(19) United States
(12) Patent Application Publication
(10) Pub. No.: US 2026/0055997 A1
(43) Pub. Date: Feb. 26, 2026

(54) LASER WEAPON AND METHOD FOR SENSING A TARGET OBJECT

(71) Applicant: MBDA Deutschland GmbH, Schrobenhausen (DE)

(72) Inventors: Gabriele MARCHI, Muenchen (DE); Wolfgang SCHOBER, Poettmes (DE); Axel REISER, Markt Indersdorf (DE); Jürgen ZOZ, Friedberg (DE)

(21) Appl. No.: 19/292,800

(22) Filed: Aug. 6, 2025

(30) Foreign Application Priority Data
Aug. 23, 2024 (DE) 102024002739.4

(51) Int. Cl. F41H 13/00; G01J 1/04; G01J 1/42; G01S 17/89

(52) U.S. Cl. CPC F41H 13/005; G01J 1/0437; G01J 1/4257; G01S 17/89

(57) ABSTRACT

A laser weapon including a laser alignment device configured to align an active laser beam for irradiating a target object, a sensing device configured to sense optical radiation reflected from the target object, and a control device connected to the laser alignment device and the sensing device, and configured to determine a position of the target object by the reflected optical radiation and to control the laser alignment device based on the determined position of the target object, wherein the sensing device has a filter device configured to dim a process light caused by the active laser beam on the target object.

### RELATED APPLICATION

This application incorporates by reference and claims priority to German patent application DE 10 2024 002739.4 filed Aug. 23, 2024.

### TECHNICAL FIELD

The present invention relates to a laser weapon and a method for sensing a target object with a laser weapon.

### BACKGROUND

To produce a sufficient effect on a target with a laser weapon, the position of the laser spot relative to the target should be kept almost constant for several seconds. Therefore, laser weapon aiming systems should be capable of following the target with sufficient accuracy for the entire duration of the engagement. Following or tracking the target is usually accomplished using cameras and other sensors. During irradiating the target with the high-energy laser, materials of the target are heated to a high temperature, resulting in a process light. What this means is that the area hit by the laser emits a powerful irradiation at different wavelengths. This irradiation is usually so strong that it outshines the target tracking sensor(s), causing the tracking of the target to be disturbed or interrupted. Although the laser spot on the target is very small in comparison with the target itself, the electrons of the overexposed pixels excited by the radiation flood the neighboring pixels on the sensor surface of the camera. As a result, large parts of the image are obscured and precise target tracking becomes difficult.

Typical solutions to this problem involve the use of an illumination laser that irradiates the target with intense monochromatic light. A narrow color filter is then applied to separate the illumination reflection from the other signals in front of the camera. In this manner, only the light from the illumination laser reaches the camera.

Nevertheless, this solution adds a lot of complexity and weight to the system and gives the target a warning. By using more specific countermeasures, such as materials that are absorbent in the specific wavelength of the illumination laser, it is possible to make tracking ineffective. In addition, the field of view is also reduced, making tracking even more difficult. Furthermore, safety standards for eye safety complicate the testing and use of such an illumination laser system.

The article Ritt et al. “Evaluation of protection measures against laser dazzling for imaging sensors” Optical Engineering Vol. 56 (3), 033108 (2017) describes various measures for filtering laser light using spectral or spatial methods.

### SUMMARY

The present invention may be embodied to provide an improved laser weapon that provides improved target sensing and tracking.

According to a first aspect of the invention, provision is made for a laser weapon. The laser weapon comprises a laser alignment device configured to align an active laser beam for irradiating a target object, a sensing device which is configured to sense optical radiation reflected from the target object, and a control device which is connected to the laser alignment device and the sensing device, and which is designed to determine a position of the target object by means of the reflected optical radiation and to control the laser alignment device based on the determined position of the target object, wherein the sensing device comprises a filter device which is configured to dim a process light caused by the active laser beam on the target object.

According to a second aspect of the invention, provision is made for a method of sensing a target object with a laser weapon. The method for sensing a target object with a laser weapon comprises detecting a target object, sensing a direction and a distance of the laser weapon to the target object, aligning and focusing an active laser beam in the determined direction for irradiating the target object, sensing the target object by means of optical radiation with a sensing device, determining a position of the target object based on the optical radiation, and tracking the target object based on the optical radiation with the laser alignment device, setting a filter device of the sensing device by means of the distance determined, so as to dim by the filter device a process light caused by the active laser beam on the target object, and aligning and focusing the active laser beam on the target object based on the determined position of the target object.

One of the ideas underlying the present invention is to use tracking which basically does not require any further direct illumination from the laser system. Thus, common lighting sources such as lamps, spotlights or sunlight during the day, which do not exceed the intensity of the process lights, are substantially sufficient. Instead of narrow spectral filtering, in order to dim or mask the process lights, there is implemented spatial filtering so as to sense an image of the target object that is not overexposed.

In this manner, there can be provided a shading with suitable dimensions for filtering the process lights using a relatively simple optical filter device. Ideally, the shading should only cover the image of the laser spot, i.e. the process lights in the image of the target object. Solutions based on the principle of the coronograph, as used in astronomy to suppress sunlight or starlight, can be used to image nearby objects such as the sun's atmosphere or exoplanets.

The strong beams of the process light are then blocked and the image of the target is dimmed with a small shadow at the position of the laser spot. Since the laser spot always takes up the same position on the camera chip or sensor surface and is therefore not subject to movement due to turbulence, it is not necessary to implement a dynamic adjustment of the position of the shading in order to track the spot.

A fixed diameter of the shading may be sufficient for some distances of the target to suppress the process lights and enable passive tracking/attack of the target.

As described above, what is concerned in the case of the radiation reflected from the target object for imaging the target object is in principle reflected radiation from ambient light sources, e.g. street lamps, sunlight or other rays. Thus, the laser weapon presented herein does not require an irradiation laser for target tracking, which makes the laser weapon less complex and more compact in design.

The laser alignment device specified hereinabove comprises not only a device for aligning the active laser beam, but also the laser generating the active laser beam and the optical system connected thereto. The laser is usually a pulsed high-power or high-energy laser, typically oscillating at a wavelength in the near infrared range, but is not limited to such lasers.

According to one embodiment, the filter device is configured to dim the process light in dependence on the size. If the targets to be engaged are distributed over a larger distance range, the use of a fixed shading size can be limiting, as distant targets could be completely covered by the shading. On the other hand, the image of the laser spot on nearby targets can be larger than the shadowing itself. A variability of the shadowing size is therefore desirable. The process light can therefore be dimmed adjustably in dependence on the distance to the target object.

According to one embodiment, the filter device comprises an optical sensing system which is configured to generate an intermediate image of the target object in an intermediate image plane on an optical axis of the optical sensing system. The intermediate image plane enables to undertake a manipulation of the image of the target object in a simple manner.

According to one embodiment, a spatial filter element is arranged in the intermediate image plane, wherein the spatial filter element has at least one aperture, in particular arranged on the optical axis. The spatial filter element of the optical sensing system can be a predominantly transparent plate or a flat or curved mirror. The aperture can be designed in its shape and size in such a manner that it optimally blocks out the process light and thus there arises a clear image of the target object.

According to one embodiment, the optical sensing system has two spatial filter elements with a respective aperture, which are designed to be displaceable along the optical axis. In this manner, the process light can be masked in dependence on size, i.e. depending on the distance and/or intensity.

According to one embodiment, the two spatial filter elements are arranged around the intermediate image plane. This is an arrangement that is particularly easy to implement in the optical sensing system.

According to one embodiment, a filter plate with a plurality of spatial filter elements with apertures of different sizes is arranged in the intermediate image plane. The plurality of spatial filter elements can be arranged exchangeably on the optical axis. For the purpose of changing the filter elements, the filter plate can be rotatably mounted. Here too, the filter plate can be configured as a flat or curved mirror. By changing the filter elements, the aperture can be applied in dependence on the size of the process light, as a result of which it can be dimmed in dependence on distance and/or intensity.

According to one embodiment, the optical sensing system has a zoom element which is arranged and configured to vary the size of the intermediate image in the intermediate image plane. By setting the zoom element, which is generally achieved by changing the distances between the individual lenses of the zoom element, it is possible to set the process light in the image of the target object in the intermediate image plane to the size of the aperture.

According to one embodiment, an optical light modulator is arranged in the intermediate image plane. The term “light modulator” here refers to a spatial modulator that achieves spatial modulation by addressing individual image elements or pixels. Prominent light modulators are a spatial polarization modulator based on liquid crystals or a “microelectromechanical system” (MEMS) mirror modulator. However, the light modulator mentioned here is not limited to these modulators.

With such a light or spatial modulator, the intermediate image of the target object can be directly manipulated, for example phase modulated, so that the process light can be easily dimmed, for example by changing the polarization in conjunction with a polarizer. Furthermore, the optical light modulator can also be configured as an amplitude modulator so that the process light in the intermediate image can be dimmed directly with the optical light modulator by addressing corresponding image elements or pixels of the optical light modulator.

According to one embodiment, the optical detection system has a polarizer. Furthermore, in conjunction with an optical light modulator arranged in the intermediate image plane, the intermediate image of the target object can be manipulated in such a manner that the process light is dimmed by addressing corresponding image elements of the optical light modulator.

According to one embodiment, a self-tinting filter element is arranged in the intermediate image plane. The material of the self-tinting filter element changes its transmission properties depending on the intensity of the light. The process light in the intermediate image experiences a significantly higher intensity than the rest of the material and will therefore set a significantly reduced transmission. In this implementation, the shading itself is dimensioned and positioned. It is therefore possible for the process light to be automatically dimmed by the self-tinting filter element.

According to one embodiment, the sensing device has a camera with a sensor surface that has a large number of image elements, wherein the sensor surface is arranged in such a manner that the target object is imaged on the sensor surface. A representation of the target object on the sensor surface makes it possible to manipulate the captured image by directly addressing the image elements of the sensor surface. For example, an amplification (gain) can be controlled according to the exposure of the respective image element.

According to one embodiment, the sensing device has a control device which is configured to switch off one or more image elements of a partial region of the sensor surface, in particular based on the incoming intensity. This allows the process light to be dimmed effectively and depending on the size without additional optics. This also reduces the power consumption of the detection device.

According to one embodiment, the target object 4 is illuminated with an additional light source. The additional light source can be an illumination laser or a lamp. This improves the visibility of the target object, making it easier to detect and track.

The above embodiments and further developments, where appropriate, can be combined with one another as desired. In particular, features of the laser weapon are applicable to the method of sensing a target object with a laser weapon, and vice versa. Further possible embodiments, further configurations and implementations of the invention also comprise, not explicitly mentioned, combinations of features of the invention described above or below with respect to the embodiment examples. In this respect, the skilled person will in particular also add individual aspects as improvements or additions to the respective basic form of the present invention.

### BRIEF DESCRIPTION OF THE DRAWINGS

The invention is explained below with reference to the figures in the drawings. The figures show:

FIG. 1 is a schematic illustration of a laser weapon according to an embodiment of the present invention;

FIG. 2 is a schematic illustration of a laser weapon according to a further embodiment of the present invention;

FIG. 3 is a schematic illustration of a laser weapon according to a further embodiment of the present invention;

FIGS. 4a to 4b are schematic illustrations of a laser weapon according to a further embodiment of the present invention;

FIG. 5 a schematic illustration of a laser weapon according to a further embodiment of the present invention;

FIG. 6 a schematic illustration of a laser weapon according to a further embodiment of the present invention;

FIG. 7 is a schematic illustration of a laser weapon according to a further embodiment of the present invention;

FIG. 8 is a schematic illustration of a laser weapon according to a further embodiment of the present invention;

FIG. 9 is a schematic illustration of a laser weapon according to another embodiment of the present invention; and

FIG. 10 is a flow diagram of a method for detecting a target object with a laser weapon according to an embodiment of the present invention.

In the figures, the same reference numbers denote identical or functionally identical components, unless otherwise indicated.

### DETAILED DESCRIPTION

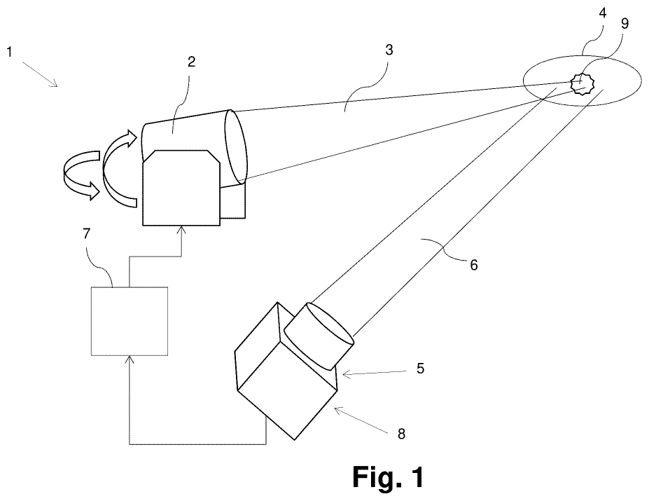

FIG. 1 shows a schematic illustration of a laser weapon 1 according to an embodiment of the present invention.

The laser weapon 1 shown in FIG. 1 comprises a laser alignment device 2. The laser alignment device 2 is configured to align an active laser beam 3 of an active laser (not shown) for irradiating a target object 4. For this purpose, the laser alignment device 2 contains corresponding equipment, in particular a tracking device with a coupled optical system, which directs the active laser beam 3 generated by a laser onto the target object 4. For the sake of clarity, these devices are not shown in this and the following figures. The laser for emitting the active laser beam 3 is usually a pulsed high-power or high-energy laser, typically oscillating at a wavelength in the near-infrared range, but not limited to such a laser.

The laser weapon 1 comprises a sensing device 5 configured to sense optical radiation 6 reflected from the target object 4. The sensing device 5 thus contains at least one optical detector for converting the reflected radiation into an electrical signal. The sensing device 5 also has a filter device 8. The filter device 8 is configured to dim a process light 9 caused by the active laser beam 3 on the target object 4. As described above, the optical radiation 6 reflected at the target object 4 may originate from ambient light sources, e.g. street lamps, sun rays or other rays. However, it can also be reflected radiation from the active laser beam 3, which is reflected at the target object 4 without spectral conversion.

The laser weapon 1 also comprises a control device 7, which is connected to the laser alignment device 2 and the sensing device 5. The control device 7 is designed to determine a position of the target object 4 by means of the reflected optical radiation. Furthermore, the control device 7 is designed to control the laser alignment device 2 based on the determined position of the target object 4.

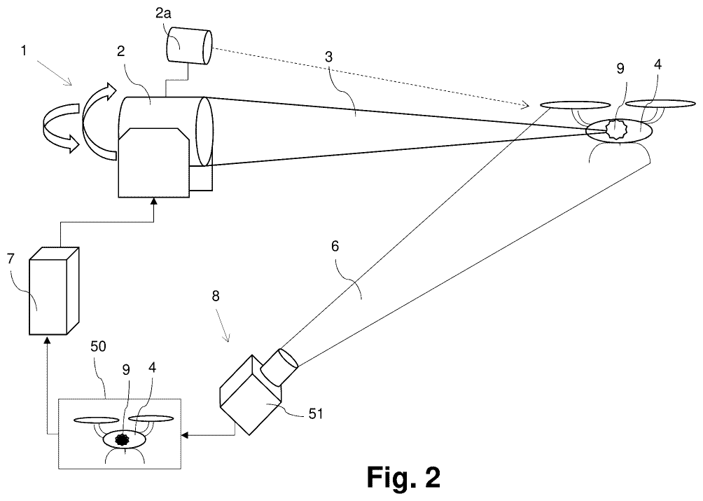

FIG. 2 shows a schematic illustration of a laser weapon 1 according to a further embodiment of the present invention. The embodiment of the laser weapon 1 described herein is compatible with the previously described embodiment of the laser weapon 1.

In this illustration of an embodiment of the laser weapon, there is illustrated the representation captured or image 50 of the target object 4. In FIG. 2 it can be seen that the process lights 9 in the image 50 are covered by the filter device 8, so that the target object 4 can be clearly seen in the image 50. Such an image 50 is recorded in this embodiment by a camera 51 of the sensing device 5. By means of this image 50, it is possible to determine the exact position of the target object 4 and to control the laser alignment device 2 accordingly so that the active laser beam 3 effectively irradiates the target object 4. For the purpose of better visibility of the target object 4, an additional light source 2a can be switched on. This can be an illumination laser or a lamp.

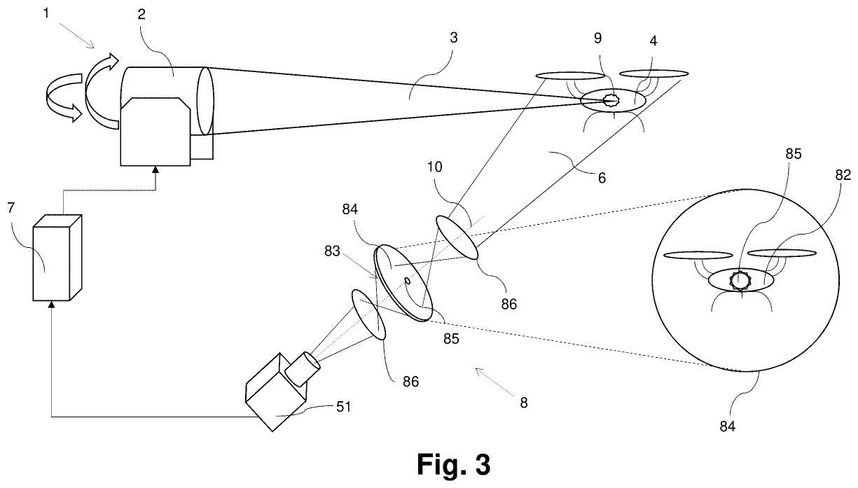

FIG. 3 shows a schematic illustration of a laser weapon according to a further embodiment of the present invention. The embodiment of the laser weapon 1 described herein is compatible with the previously described embodiments of the laser weapon 1.

The filter device 8 has an optical sensing system 81 which is configured to generate an intermediate image 82 of the target object 4 in an intermediate image plane 83 on an optical axis 10 of the optical sensing system 81.

FIG. 3 shows the intermediate image plane 83 there is arranged a spatial filter element 84. The spatial filter element 84 has at least one aperture 85 arranged on the optical axis 10. In this manner, the process lights 9 are dimmed or masked out in the intermediate image 82 of the target object 4, resulting in a clear image 50 (no longer shown in FIG. 3 and the following figures) of the target object 4 captured by the camera 51.

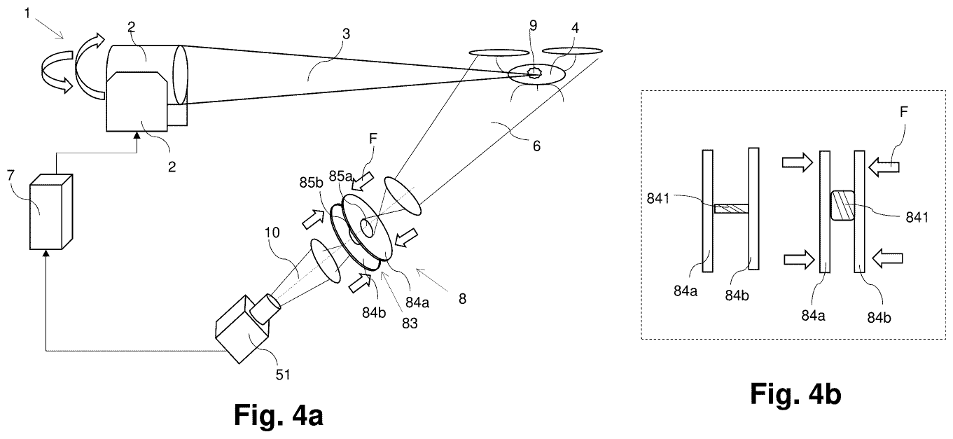

FIG. 4 shows a schematic illustration of a laser weapon 1 according to a further embodiment of the present invention. The embodiment of the laser weapon 1 described here is compatible with the embodiments of the laser weapon 1 described previously with reference to FIGS. 1 and 2.

In the embodiment of the laser weapon 1 shown in FIG. 4a, the filter device 8 is configured to dim the process lights 9 in dependence on the size. The optical sensing system 81 of the laser weapon 1 of this embodiment has two spatial filter elements 84a, 84b with respective apertures 85a, 85b, which are configured to be displaceable along the optical axis 10. This allows the two apertures 85a, 85b to create a shading in dependence on the size by shifting along the axis. The two spatial filter elements 84a, 84b are arranged around the intermediate image plane 83 so that the process lights 9 in the intermediate image 82 of the target object 4 can be effectively dimmed depending on the distance to the laser weapon 1.

In certain embodiments for implementing the aperture 85, an absorbent elastic material 841 may be disposed between the filter elements 84a, 84b, as also shown in FIG. 4b. Here, the filter elements 84a, 84b are designed to be transparent, for example made of glass. When the two filter elements 84a, 84b approach each other, the transverse dimension of the absorbing elastic material 841 changes due to compression. The compression is generated by an external force F exerted on the filter elements 84a, 84b, as shown in FIG. 4. If the filter elements 84a, 84b now move away from each other, the transverse dimension of the absorbing elastic material 841 changes due to stretching. This makes it possible to adjust the size of the aperture 85 and thus the shading of the process light 9.

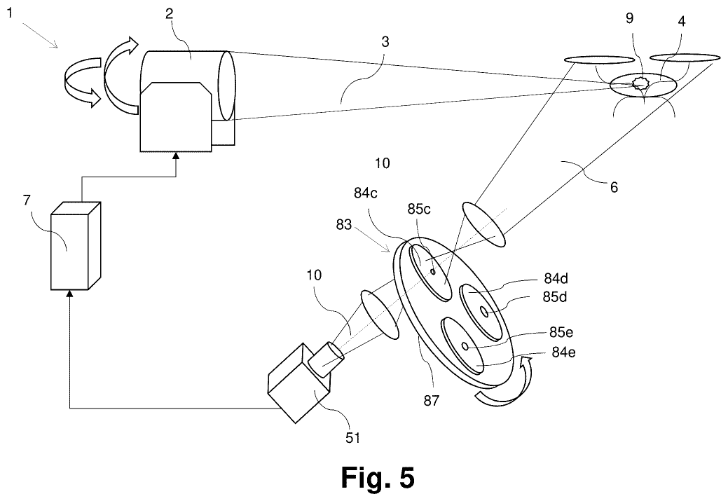

FIG. 5 shows a schematic illustration of a laser weapon 1 according to a further embodiment of the present invention. The embodiment of the laser weapon 1 described here is compatible with the embodiments of the laser weapon 1 described previously with reference to FIGS. 1 and 2.

In this embodiment of the laser weapon 1, the filter device 8 is also configured to dim the process light 9 depending on the size. For this purpose, a filter plate 87 with a plurality of spatial filter elements 84c-e with corresponding apertures 85c-e of different sizes is arranged in the intermediate image plane 83. Thus, the plurality of spatial filter elements 84c-e can be interchangeably arranged on the optical axis. In the present embodiment, the filter plate 87 is rotatably mounted so as to be able to be changed from one spatial filter element 84c-e to another spatial filter element 84c-e by rotation. In FIG. 5 it can be seen that the spatial filter element 84c with the aperture 85c, which is smaller than the apertures 85d and 85e of the spatial filter elements 84d and 84e, is located on the optical axis 10. If the target object 4 now approaches the laser weapon 1, the intermediate image 82 and thus also the representation of the process light 9 becomes larger. It is then possible to switch to one of the other spatial filter elements 84d and 84e for arrangement on the optical axis 10 by rotating it. The invention is obviously not limited to the circular rotatable filter plate 87 shown in FIG. 5. In particular, the filter plate 87 can be designed in such a manner that a filter element 84c-e is arranged so that it can be changed by a translational movement. Filter plates 87 can also be arranged one behind the other on the optical axis 10 in order to achieve a combination of the filter device 8 of this embodiment and the filter device 8 shown in FIG. 4.

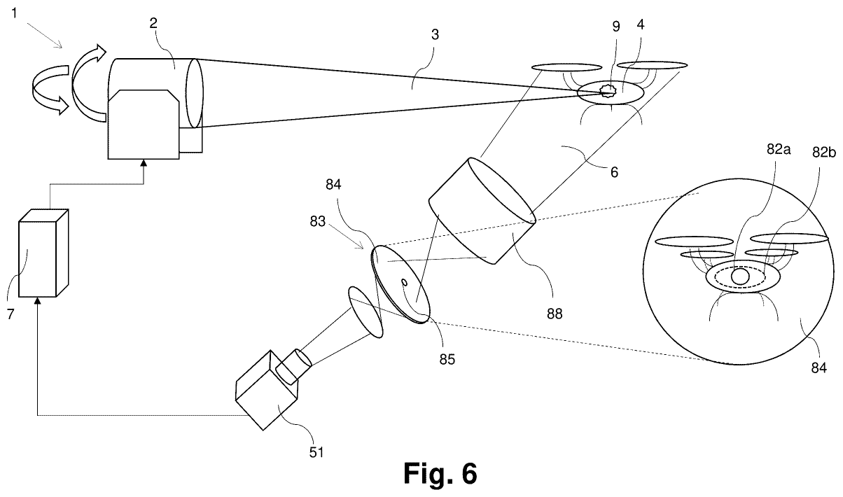

FIG. 6 shows a schematic illustration of a laser weapon 1 according to a further embodiment of the present invention. The embodiment of the laser weapon 1 described here is compatible with the embodiments of the laser weapon 1 described previously with reference to FIGS. 1 and 2.

In this embodiment of the laser weapon 1, the filter device 8 is also configured to dim the process light 9 depending on the size. For this purpose, the optical sensing system 81 has a zoom element 88 which is arranged and configured to vary the size of the intermediate image 82a, 82b in the intermediate image plane 83, as indicated in the enlarged representation of the image of the target object 4 in FIG. 6. Thus, by setting the zoom element 88 accordingly, it is possible to adjust the size of the process lights 9 in the intermediate image so that it matches the size of the aperture 85 of the filter element 84 and effective shading is generated.

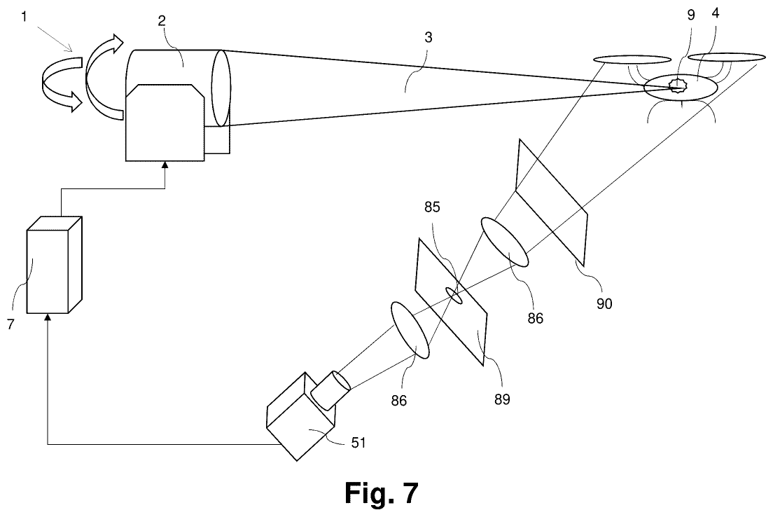

FIG. 7 shows a schematic illustration of a laser weapon 1 according to a further embodiment of the present invention. The embodiment of the laser weapon 1 described here is compatible with the embodiments of the laser weapon 1 described previously with reference to FIGS. 1 and 2.

In this embodiment of the laser weapon 1, the filter device 8 is also configured to dim the process light 9 depending on the size. For this purpose, an optical light modulator 89 is arranged in the intermediate image plane. A surface around the optical axis can be made opaque by controlling it accordingly. In particular, the optical light modulator 89 may be a spatial polarization modulator or a “microelectromechanical system” (MEMS) mirror modulator or any other suitable optical spatial modulator. The aperture 85 as the region of shadowing can be varied within the resolution of the optical light modulator 89. Depending on the design of the light modulator, the optical sensing system 81 can also have one or more polarizers 90, as shown in FIG. 7, which can be arranged in front of or behind the optical light modulator 89 in order to block radiation of one polarization state.

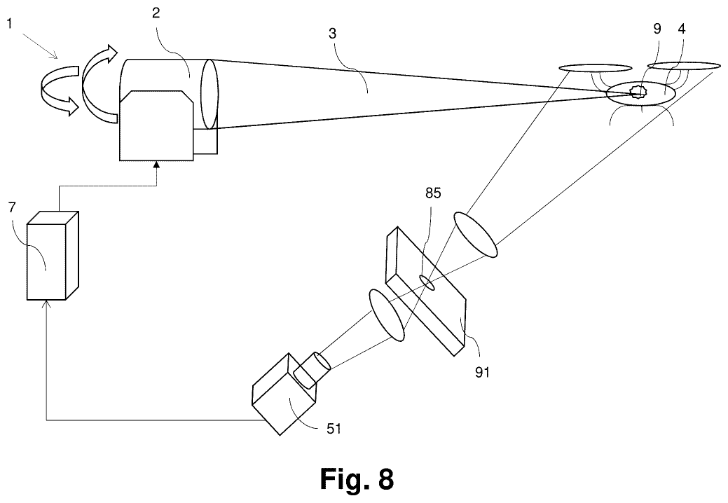

FIG. 8 shows a schematic illustration of a laser weapon 1 according to a further embodiment of the present invention. The embodiment of the laser weapon 1 described here is compatible with the embodiments of the laser weapon 1 described previously with reference to FIGS. 1 and 2.

In this embodiment of the laser weapon 1, the filter device 8 is also configured to dim the process light 9 depending on the size. For this purpose, a self-tinting filter element 91 is arranged in the intermediate image plane 83. The self-tinting filter element 91 is configured in such a manner that it changes its absorption capacity depending on the intensity of the incident reflective radiation 6. As a result, the absorption coefficient of the material of the self-tinting filter element 91 is increased to such an extent at the location of the self-tinting filter element 91 at which the intensive process light 9 is imaged in the intermediate image plane 83 that the process light 9 is de facto masked out.

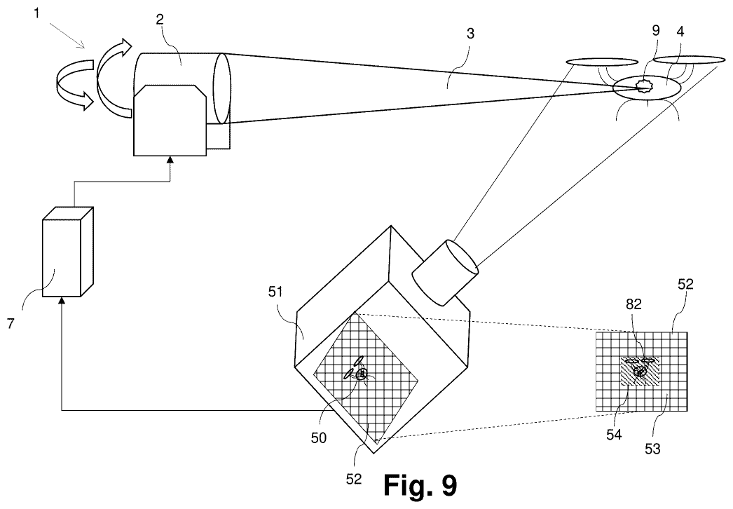

FIG. 9 shows a schematic illustration of a laser weapon 1 according to a further embodiment of the present invention. The embodiment of the laser weapon 1 described here is compatible with the embodiments of the laser weapon 1 described previously with reference to FIGS. 1 and 2.

In this embodiment of the laser weapon 1, the filter device 8 is also configured to dim the process light 9 depending on the size.

As in the previously described embodiments of the laser weapon 1, the sensing device 5 has a camera 51, which has a sensor surface 52. The sensor surface 52 itself has a plurality of image elements 53. The sensor surface 52 is generally arranged such that the target object 4 is imaged on the sensor surface 52 in an image 50. In this manner, there exists a possibility of determining the position of the target object 4 in the easiest way.

In the embodiment of the laser weapon 1 shown in FIG. 9, the sensing device 5 has a control device (not shown) which is configured to switch off one or more image elements 53 of a partial region 54 of the sensor surface 52. The partial region 54 is preferably defined based on the incident intensity, so that one of the process lights 9 in the image 50 of the target object 4 is dimmed or shadowed. By switching off the image elements 53 in the partial region 54, overexposure of the image elements 53 adjacent to the partial region 54 is prevented. In this manner, the position of the target object 4 can be determined with high accuracy by means of the image 50 on the sensor surface 52.

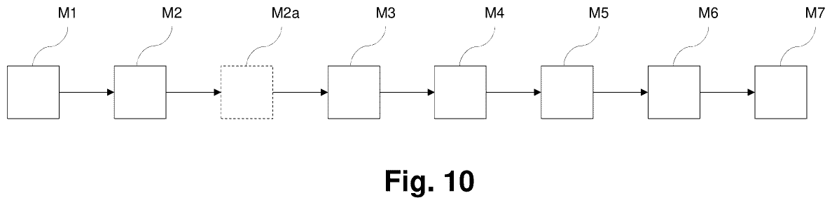

FIG. 10 shows a flow diagram of a method for sensing a target object with a laser weapon according to an embodiment of the present invention.

In the method for sensing a target object 4 with a laser weapon 1, a target object 4 is first detected M1. This can be done, for example, by means of a radar system. Then, there are determined a direction and a distance of the laser weapon 1 to the target object 4 M2. Now the target object 4 is sensed M3 by means of optical radiation with a sensing device 5. A position of the target object 4 is determined on the basis of the optical radiation M4. The target object is now tracked M5 based on the optical radiation with the laser alignment device 2, so that a representation 50 of the target object 4 is held in a predefined position of a sensor surface 52 of the detection system 5. This predefined position is normally in the center of the sensor surface. A filter device 8 of the sensing device 5 is set based on the distance determined M6, so that the filter device 8 dims a process light 9 caused by the active laser beam 3 on the target object 4. This means that the filter device 8 is now set from initial output values with optimum parameters according to the information of the determined distance to the target object 4. The active laser beam 3 is then aligned with the target object 4 based on the determined position of the target object 4 and focused M7. The sensing device 5 is not obscured by the process light 9 thanks to the already set filter device 8. Furthermore, the information about the target movement of the target object 4 can be further determined at the aiming system or laser alignment device 2 to achieve the active laser beam 3 and to set the filter device 8.

In an optional step, the target object 4 can be illuminated with an additional light source 2a, such as an illumination laser or a lamp M2a.

In the preceding detailed description, various features have been summarized in one or more examples to improve the stringency of the illustration. However, it should be clear in this respect that the above description is merely illustrative and in no way limiting in nature. It is intended to cover all alternatives, modifications and equivalents of the various features and exemplary embodiments. Many other examples will be immediately and directly obvious to a skilled person in view of the above description.

The exemplary embodiments have been selected and described in order to best illustrate the principles underlying the invention and its possible applications in practice. As a result, skilled persons can optimally modify and use the invention and the various exemplary embodiments thereof in relation to the intended use. In the claims as well as in the description, the terms “including” and “having” are used as neutral language terms for the corresponding terms “comprising”. Furthermore, the use of the terms “a”, “an” and “one” is not intended to fundamentally exclude a plurality of features and components described in such a manner.

### REFERENCE NUMBERS USED IN DRAWINGS

1 laser weapon
2 laser alignment device
2a additional light source
3 active laser beam
4 target object
5 sensing device
7 control device
8 filter device
9 process light
10 optical axis
50 image, representation
51 camera
52 sensor surface
53 image elements
54 partial region
81 optical sensing system
82 intermediate image
82a, 82b intermediate images
83 intermediate image plane
84, 84a-e spatial filter element
85, 85a-e aperture
841 absorbing elastic material
87 filter plate
88 zoom element
89 optical light modulator
90 polarizer
91 self-tinting filter element

What is claimed:

1. A laser weapon including:
a laser alignment device configured to align an active laser beam configured to irradiate a target object;
a sensing device configured to sense optical radiation reflected from the target object, and
a control device connected to the laser alignment device and the sensing device and which is configured to determine a position of the target object by the reflected optical radiation and to control the laser alignment device based on the determined position of the target object,
wherein the sensing device includes a filter device configured to dim a process light caused by the active laser beam illuminating the target object.

2. The laser weapon according to claim 1, wherein the filter device is configured to dim the process light in dependence on the size.

3. The laser weapon according to claim 1, wherein the filter device comprises an optical sensing system configured to generate an intermediate image of the target object in an intermediate image plane on an optical axis of the optical sensing system.

4. The laser weapon according to claim 3, wherein a spatial filter element is in the intermediate image plane, wherein the spatial filter element comprises at least one aperture arranged on the optical axis.

5. The laser weapon according to claim 3, wherein the optical sensing system comprises two spatial filter elements with respective apertures, which are configured to be displaceable along the optical axis.

6. The laser weapon according to claim 5, wherein the two spatial filter elements are arranged around the intermediate image plane.

7. The laser weapon according to claim 3, wherein a filter plate comprising a plurality of spatial filter elements with apertures of different sizes is arranged in the intermediate image plane, wherein the plurality of spatial filter elements can be arranged exchangeably on the optical axis.

8. The laser weapon according to claim 3, wherein the optical sensing system comprises a zoom element arranged and configured to vary the size of the intermediate image in the intermediate image plane.

9. The laser weapon according to claim 3, wherein an optical light modulator is arranged in the intermediate image plane.

10. The laser weapon according to claim 3, wherein the optical detection system comprises a polarizer.

11. The laser weapon according to claim 3, wherein a self-tinting filter element is in the intermediate image plane.

12. The laser weapon according to claim 1, wherein the sensing device comprises a camera including a sensor surface comprising a plurality of image elements, and wherein the sensor surface is arranged in such that the target object is imaged on the sensor surface.

13. The laser weapon according to claim 12, wherein the sensing device has a control device configured to switch off one or more image elements of a partial region of the sensor surface based on incident intensity.

14. A method for sensing a target object with a laser weapon comprising:
detecting a target object;
determining a direction and a distance of the laser weapon to the target object;
sensing the target object by optical radiation with a sensing device;
determining a position of the target object based on the optical radiation;
tracking the target object based on the optical radiation with the laser alignment device;
setting a filter device of the sensing device by means of the distance determined to dim by the filter device a process light caused by the active laser beam on the target object, and
aligning and focusing the active laser beam on the target object based on the determined position of the target object.

15. The method according to claim 14, further comprising illuminating the target object with an additional light source.
